(19) United States
(12) Patent Application Publication
(10) Pub. No.: US 2012/0328249 A1
(43) Pub. Date: Dec. 27, 2012

(54) FIBER OPTIC CABLE ASSEMBLIES HAVING A CRIMP BAND DISPOSED ABOUT A CUSHIONING MEMBER ALONG WITH METHODS FOR MAKING THE SAME

(76) Inventors: Jose Manuel Hernandez Quintana, Tamaulipas (MX); Wesley Allan Yates, Lenoir, NC (US)

(21) Appl. No.: 13/530,408

(22) Filed: Jun. 22, 2012

Related U.S. Application Data
(60) Provisional application No. 61/500,936, filed on Jun. 24, 2011.

(51) Int. Cl. G02B 6/36; G02B 6/46; G02B 6/44

(52) U.S. Cl. 385/87; 29/428

(57) ABSTRACT

The disclosure is directed to cable assemblies having at least one fiber optic connector and methods for making the same. In particular, fiber optic cable assemblies having a crimp band disposed about a cushioning member on a fiber optic cable along with methods for making the same are disclosed. The cable assemblies including the cushioning member are advantageous since they provide a load distribution of the crimp band about the fiber optic cable which may preserve optical performance and/or enable the use of fiber optic cables having smaller diameters. Additionally, the fiber optic cables of the cable assemblies may be sub-units of a larger cable.

### RELATED APPLICATIONS

This application claims the benefit of priority under 35 U.S.C. §119 of U.S. Provisional Application Ser. No. 61/500,936 filed on Jun. 24, 2011 the content of which is relied upon and incorporated herein by reference in its entirety.

### BACKGROUND

The disclosure is directed to cable assemblies having at least one fiber optic connector. More specifically, the disclosure is directed to cable assemblies having a crimp band disposed about a cushioning member along with methods for making the same.

Optical fiber is increasingly being used for a variety of applications, including but not limited to broadband voice, video, and data transmission. As bandwidth demands increase the optical fibers are being deployed in communication networks that have limited space available for the cable assemblies of the network. Consequently, this limited space availability is driving a need for higher density of connection in places like the data center and the like. Moreover, as density of the cabling in the network increases cooling of the equipment in the network becomes an issue since the dense cabling can cause issues with airflow and cooling the equipment. Thus, there is a need to provide cable assemblies having relatively small footprints for allowing dense cabling while still allowing adequate cooling in applications such as data centers.

### SUMMARY

The disclosure is directed to cable assemblies and methods for making the same. One embodiment of the disclosures is directed to a cable assembly including a fiber optic cable having a first end and at least one optical fiber disposed within a longitudinal passageway of the fiber optic cable with a cushioning member disposed about the fiber optic cable, and a connector attached to the first end of the fiber optic cable. The connector includes a crimp band disposed over the cushioning member, and the crimp band secures the connector to the first end of the cable.

Another embodiment of the disclosure is directed to a cable assembly including a fiber optic cable having a first end and a plurality of optical fibers disposed within a longitudinal passageway of a jacket of the fiber optic cable, a cushioning member disposed about the jacket of the fiber optic cable, and a connector attached to the first end of the fiber optic cable. The connector includes a crimp band disposed over the cushioning member, and the crimp band has a stepped profile with a first portion of the crimp band secured to the fiber optic cable and a second portion of the crimp band secured to a portion of the connector.

Also disclosed are methods of making cable assemblies including the steps of providing a fiber optic cable having a first end and at least one optical fiber disposed within a longitudinal passageway of the fiber optic cable, placing a cushioning member about the first end of the fiber optic cable, and installing a connector on the first end of the fiber optic cable so that a crimp band of the connector is disposed over the cushioning member and the crimp band secures the fiber optic connector to the first end of the cable.

Additional features and advantages will be set forth in the detailed description which follows, and in part will be readily apparent to those skilled in the art from that description or recognized by practicing the same as described herein, including the detailed description that follows, the claims, as well as the appended drawings.

It is to be understood that both the foregoing general description and the following detailed description present embodiments that are intended to provide an overview or framework for understanding the nature and character of the claims. The accompanying drawings are included to provide a further understanding of the disclosure, and are incorporated into and constitute a part of this specification. The drawings illustrate various embodiments and together with the description serve to explain the principles and operation.

### BRIEF DESCRIPTION OF THE FIGURES

FIG. 1 is a cross-sectional view of an explanatory fiber optic cable used for cable assemblies as disclosed herein;

FIG. 2 is a cross-sectional view of another explanatory fiber optic cable using the cable of FIG. 1 as a sub-unit of within the fiber optic cable;

FIG. 3 is a cross-sectional view of another explanatory fiber optic cable for use with the concepts disclosed herein;

FIG. 4 is a perspective view of a cable assembly having furcation body with connectors disposed on the respective ends of the cable sub-units;

FIG. 5 is a perspective view of a fiber optic cable having a first end prepared for termination with a fiber optic connector;

FIG. 6 is a perspective view of the fiber optic cable of FIG. 5 with a cushioning member disposed about the cable;

FIG. 7 shows select components of the connector threaded onto a fiber optic cable;

FIG. 8 shows a crimp band being secured about the cushioning member of the assembly in FIG. 6;

FIG. 9 shows select components of the connector on a fiber optic cable;

FIG. 10 shows the crimp band disposed over the cushioning member and securing the connector to the first end of the cable;

FIG. 11 shows an assembled connector secured to a first end of the cable with the boot slid back to show the crimp band securing the connector to the end of the cable;

FIG. 12 shows a perspective view of a fully assembled connector on the end of the fiber optic cable;

FIG. 13 is a top view of optical fibers of a fiber optic cable disposed in a fiber tray; and

FIG. 14 depicts a cross-sectional view of the fiber tray in FIG. 13.

### DETAILED DESCRIPTION OF THE PREFERRED EMBODIMENTS

Reference will now be made in detail to the preferred embodiments of the disclosure, examples of which are illustrated in the accompanying drawings. Whenever possible, like reference numbers will be used to refer to like components or parts.

The cable assemblies described herein are suitable for making optical connections for a variety of devices. The concepts of the disclosure advantageously allow the simple, quick, and economical cable assemblies while also enabling the use of fiber optic cables having smaller diameters and/or providing a load distribution of the crimp band about the fiber optic cable which may preserve optical performance. Reference will now be made in detail to the preferred embodiments, examples of which are illustrated in the accompanying drawings. Whenever possible, like reference numbers will be used to refer to like components or parts.

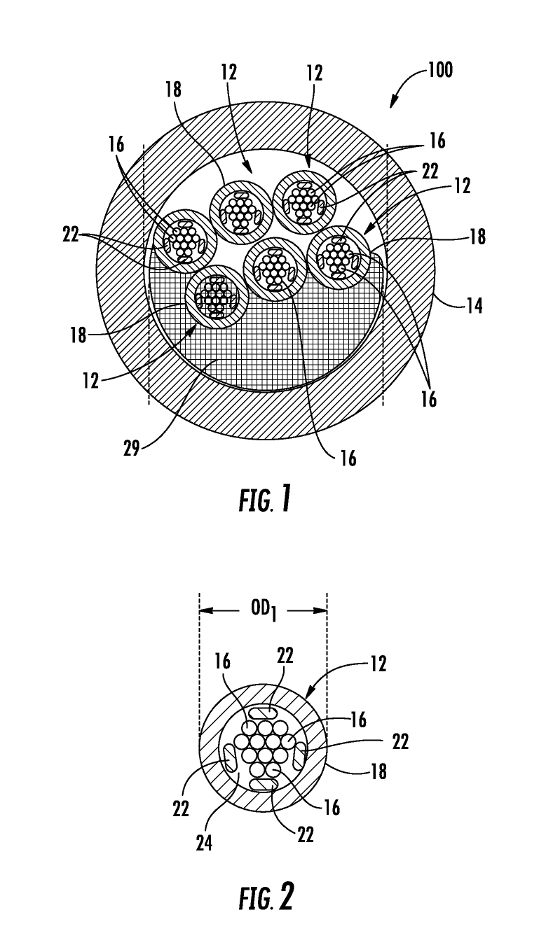

FIG. 1 depicts a cross-sectional view of an explanatory fiber optic cable 12 suitable for making cable assemblies according to the concepts disclosed herein. Fiber optic cable 12 includes at least one optical fiber 16 disposed within a longitudinal passageway 24 of the fiber optic cable having a first end (not numbered). Fiber optic cable 12 may include other optional components such as strength members 22. In other words, fiber optic cable 12 includes a plurality of optical fibers 16 and strength members 22 loosely disposed within the passageway 24. Other suitable cables may include ripcords, electrical conductors, water-blocking components, and/or other known cable components. The cable assembly concepts disclosed herein may be used with any suitable fiber optic cable such as a single-fiber cable, a tight buffered optical fiber (e.g., a 900 micron buffered fiber) 12′ such as shown in FIG. 3 or a jumper cable having at least one optical fiber disposed within a longitudinal passageway.

FIG. 2 depicts a cross-sectional view of another explanatory fiber optic cable 100 using one or more cables 12 as a sub-unit of within fiber optic cable 100. In other words, fiber optic cable 100 has a plurality of sub-units 12 disposed within a cable jacket 14 as shown (i.e., the sub-units 12 form a portion of a larger cable). Fiber optic cable 100 may also optionally include further strength members 20 disposed outward of sub-units 12, but within cable jacket 14 as shown. Fiber optic cable 100 may used to form a larger cable assembly including a furcation body.

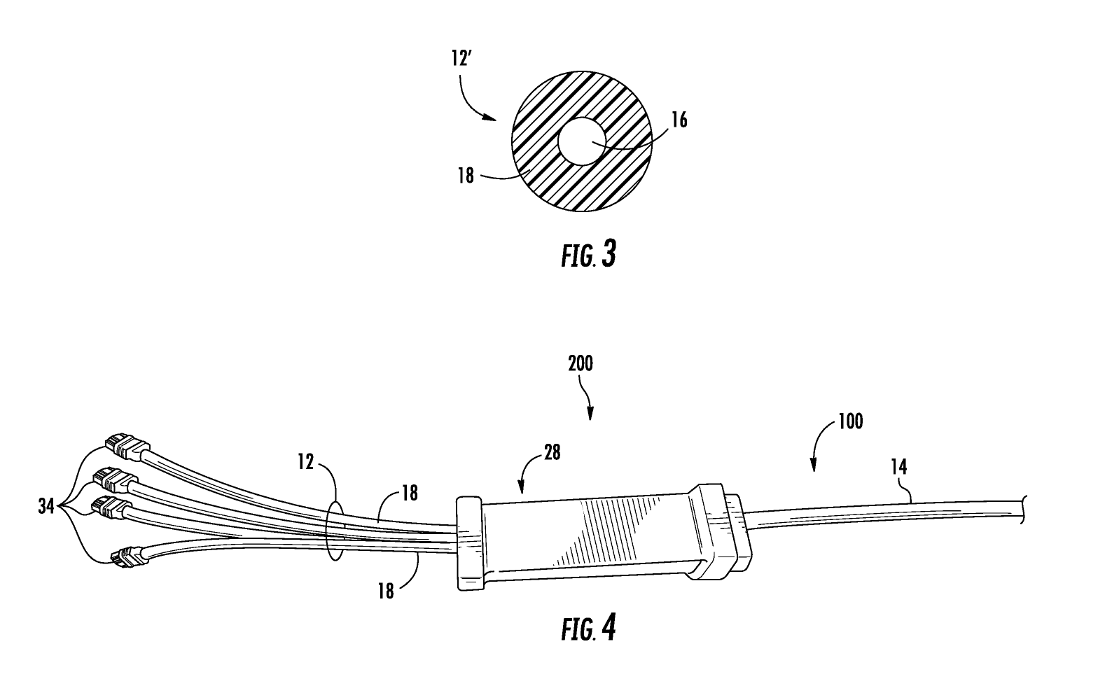

By way of example, FIG. 4 depicts cable assembly 200 having a furcation body 28 with a plurality of sub-units 12 extending from one end thereof. As shown, furcation body 28 has fiber optic cable 100 entering the right end and a plurality of sub-units 12 exiting the left end. Inside the furcation body 28 the cable jacket 14 is removed to expose the sub-units 12 and strength members 14. The sub-units 12 pass through the furcation body 28 and are terminated with a plurality of multi-fiber connector 34, respectively. The strength members 14 are strain relieved inside the furcation body 28 and the individual furcated legs (i.e., the sub-units) may include strength members within jacket 18 for providing strain relieve within each furcated leg by being attached to connector 34. Of course, the concepts disclosed herein may be used with other cable assemblies having plurality of sub-units such as depicted in FIG. 4. Likewise, the connector attached to the first end of the cable may be a multi-fiber connector or a single-fiber connector as desired. Simply stated, the concepts disclosed herein may be used with any suitable fiber optic cable, connector and/or components.

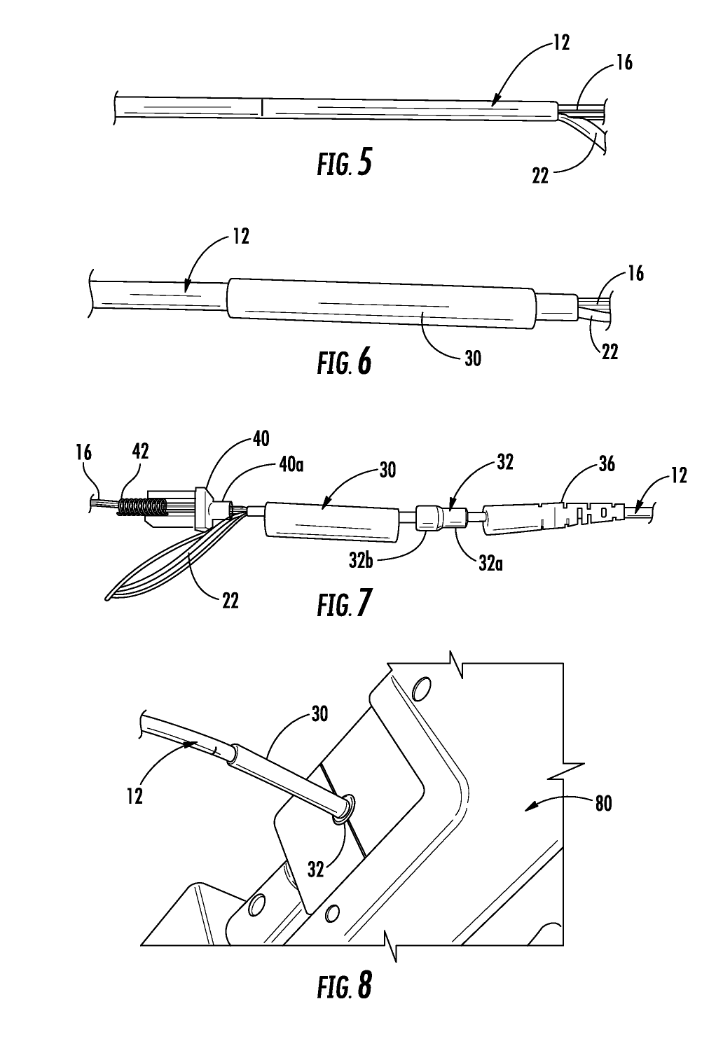

The concepts disclosed herein for using a cushioning member on the cable assembly are similar regardless of the type of cable assembly that is employed. FIG. 5 shows the first end of fiber optic cable 12 prepared for connectorization by removing a portion of the cable jacket 18 to expose optical fibers 16 and optional strength members 22. FIG. 6 depicts a cushioning member 30 disposed about the prepared fiber optic cable 12 of FIG. 4 or any other suitable cable. Specifically, cushioning member 30 is placed about a first end of the fiber optic cable 12 at the desired location as shown. In other words, cushioning member 30 is threaded onto a portion of the fiber optic cable 12 so that it is disposed over jacket 18 at the desired location. Thereafter, a connector is attached to the first end of the fiber optic cable. The connector includes a crimp band 32 (FIG. 11) disposed over the cushioning member, and the crimp band secures the connector to the first end of the fiber optic cable as discussed herein. In other words, the crimp band 32 of the connector 34 may also be disposed about the cable jacket of the fiber optic cable along with the cushioning member.

Cushioning member 30 may be any suitable material that may be disposed about the fiber optic cable and allows crimping thereto. By way of example, cushioning member 30 may be a heat-shrink material, a slip-fit covering, a polymer-based sleeve, a rubber-based sleeve, or other suitable structure. In this embodiment, cushioning member 30 is a heat-shrink tubing that is disposed about the fiber optic cable and then heated to fit the same to the outer surface OD₁ of the fiber optic cable, thereby inhibiting movement of the same. The heat shrink cushioning member may be glued-lined and/or have flame-retardant properties if desired. In other words, the outer surface or outer diameter of the fiber optic cable is protected and the size of the assembly is increased by the cushioning member 30 at the location of the cushioning member. Consequently, when a crimp band is disposed over the cushioning member and secured a larger volume of material is available for distributing the load from the crimp band about the fiber optic cable.

Stated another way, the cushion member 30 acts as a cushion for crimp forces by distributing the forces over a larger surface area so that optical performance may be preserved. In other words, forces from the crimp band are further insulated from the optical fiber(s) within the passageway of the cable for inhibiting optical attenuation due to crimping forces. Moreover, using the cushioning member enables the use of a fiber optic cable having a smaller diameter (i.e., a thinner jacket) when attaching a fiber optic connector to a first end of the cable. Further, the time and expense of developing of a different sized hardware package for the smaller sized cable may be avoided. By way of explanatory example, the outer surface OD₁ of the fiber optic cable is about 2.0 millimeters (mm) and the cushioning member 30 is placed about the first end of the fiber optic cable, thereby upsizing the diameter of the assembly to about 3.0 mm at the cushioning member. Of course, fiber optic cables may have other suitable sizes for outer surface OD₁ and/or the upsizing with the cushioning member for receiving a portion of the crimp band of connector 34 thereover. Further, if both ends of the fiber optic cable are terminated with connectors, then both ends can include cushioning members as disclosed herein.

Thereafter, the connector 34 may be assembled in a normal manner for terminating a first end of the fiber optic cable with the same. Connector 34 may have any suitable components and/or may be any suitable type such as single-fiber, multi-fiber or hardened connector. FIG. 7 shows select components of connector 34 threaded onto a fiber optic cable, but before the cushioning member 30 is attached to the fiber optic cable 12. Specifically, FIG. 7 shows crimp band 32, a boot 36, a spring push 40 and spring 40 threaded over a portion of fiber optic cable 12. Crimp band 32 has a suitable geometry for the fiber optic cable and connector being constructed. For instance, the crimp band may be a simple band with a single diameter or have a stepped profile with multiple portions. By way of explanatory example, crimp band 32 shown in FIG. 7 has a stepped profile with a first portion 32a of the crimp band being secured to the fiber optic cable and a second portion 32b of the crimp band being secured to a portion of the fiber optic connector 34. Specifically, the second portion 32b of crimp band 32 is secured to a portion 40a of the spring push 40. Moreover, when assembled the strength members 22 may be positioned between portion 40a of spring push 40 and the second portion 32b of crimp band 32 for strain relieving the strength members 22 of fiber optic cable 12 thereto.

During assembly crimp band 32 is disposed over the prepared fiber optic cable with cushioning member 30 thereon like shown in FIG. 6 at the desired position and then the crimp band 32 is secured to the fiber optic cable 12 using a suitable crimping tool 80 as shown in FIG. 8. In other words, crimping tool 80 secures the first portion 32a of crimp body 32 about the cushioning member 30 and fiber optic cable 12 by crushing the first portion 32a of crimp band 32 around the same. Consequently, the crimp band is disposed about the cable jacket 18 and a portion of cushioning member 30.

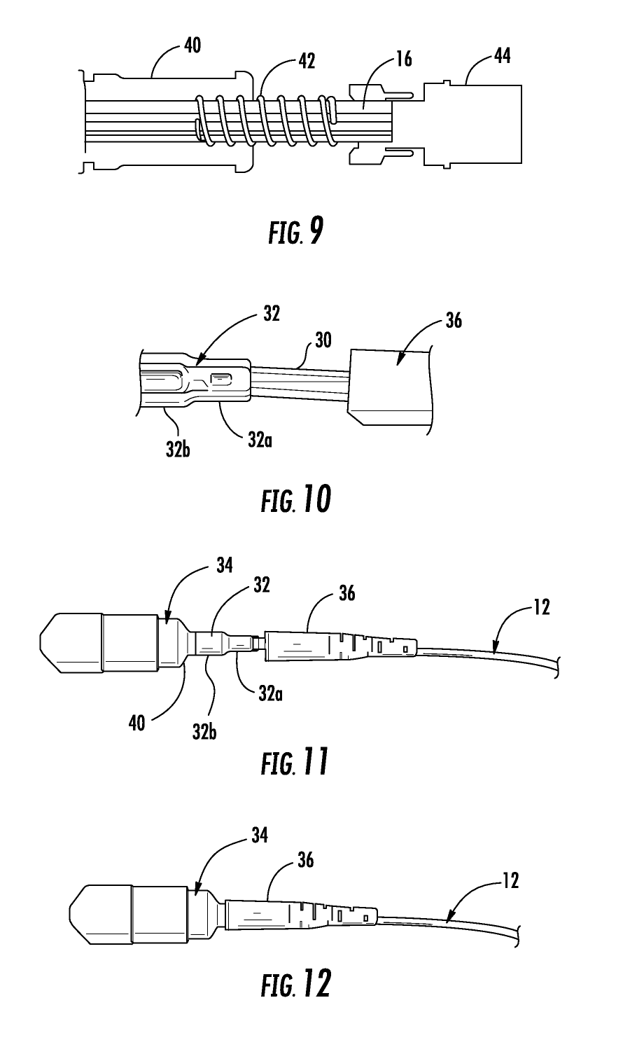

FIG. 9 shows select components of the connector on a fiber optic cable. Specifically, FIG. 9 shows optical fibers 16 attached to a ferrule 44 before the ferrule is secured to spring push 40. As known, optical fibers 16 are inserted into fiber bores of the ferrule so they extend beyond the front face and then secured using a suitable method such as by an adhesive. Thereafter, the excess length of optical fibers 16 extending beyond the front face of ferrule 44 are cleaved as appropriate and then the front of the ferrule with the optical fiber is finished/polished as desired. Other methods of finishing the optical fibers 16 extending beyond the front face of ferrule are also possible such as laser processing with or without an accompanying mechanical polish. Thereafter, the ferrule 44 is assembled with the spring push 40 so it can float within the connector 42. In other words, spring 42 biases ferrule 44 forward and the spring 42 is disposed between the ferrule 44 and spring push 40.

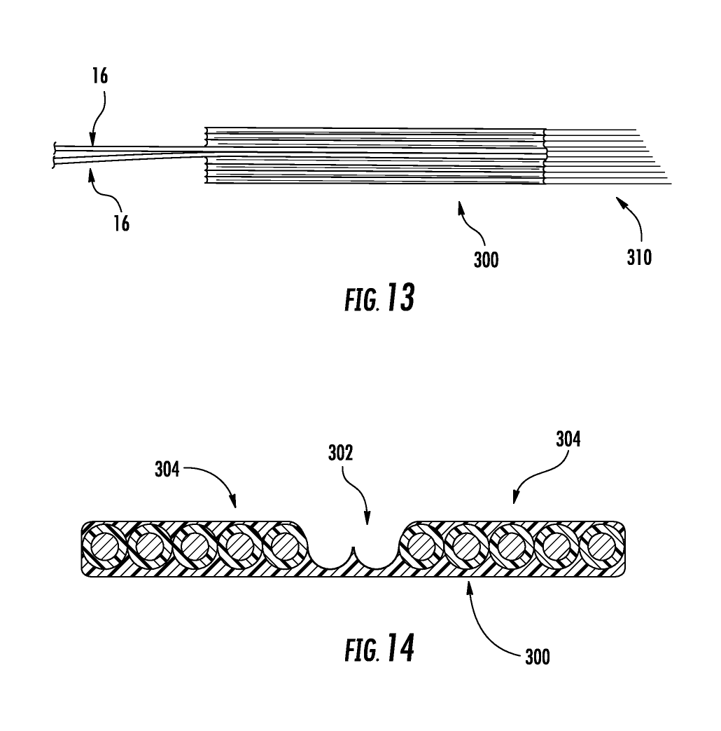

FIGS. 10 and 11 show crimp band 32 disposed over cushioning member 30 and securing the connector 34 to the first end of the fiber optic cable. More specifically, FIG. 11 shows a nearly assembled 34 connector secured to a first end of the cable with the boot slid back to show the crimp band securing the connector to the end of the cable. As shown, first portion 32a of crimp band 32 is secured to fiber optic cable 12 and second portion 32b of crimp band 32 is secured to portion 40a of spring push 40. The second portion 32b of crimp band 32 can be secured to the connector 34 using a suitable tool similar to tool 80 as shown in FIG. 8. FIG. 11 also shows connector 34 assembled with inner and outer housings (not numbered) along with a dust cap (not numbered) on the ferrule for protecting the same from dust, debris and/or damage. FIG. 12 shows a perspective view of a fully assembled connector on the end of the fiber optic cable with the boot slid-up over the back end of connector 34.

Additionally, the cable assemblies disclosed can include other features and/or structures as desired. For instance, the craft may desire to ribbonize the ends of loose optical fibers over a short length for correct alignment and easy insertion into the rear end of a ferule of the multi-fiber connector as well-known in the art. As one example, the craft may align the loose fibers in the desired sequence and then apply a tape or adhesive over a short length of the optical fibers to hold the same for insertion into the rear end of the ferrule. In other embodiments, the fiber optic cable including a plurality of optical fibers loosely disposed within the passageway may be aligned within the connector using a fiber tray 300 as shown in FIGS. 13 and 14. The fiber tray 300 is useful for cable assemblies when the ferrule of the connector has more ports (i.e., fiber bores) than active transmission optical fibers 16 in the cable (i.e., optical fibers for transmission of signals). Simply stated, the optical fibers 16 of the cable must be aligned into the proper bores of the ferrule, which can be difficult due to the very small structure of the bores in the ferrule. By way of explanatory example, the cable may have two optical fibers 16 and the ferrule has twelve bores for receiving optical fibers and the fibers must be aligned to the desired bores for optical transmission. Consequently, fiber tray 300 can aid in proper positioning of the two optical fibers relative to the twelve bores of the ferrule.

As shown in FIG. 13, two optical fibers 16 are placed into channels 302 of ribbon tray 300 for aligning optical fibers 16 in the center positions (e.g., positions 6 and 7, but any of the positions are possible) of a twelve position array. Although, the example shows two optical fibers 16, other embodiment can have any suitable number of optical fibers 16. Thereafter, a binding agent such as a tape, adhesive such as a glue stick or the like can be applied thereover if desired to maintain the position of the optical fibers 16 in the fiber tray 300. Further, the array of twelve fibers (i.e., the two optical fibers 16 of the cable and non-transmitting fibers of the ten fiber tray) can optionally have an angled cut 310 as shown for easily beginning the insertion process of the fiber array into the bores of the ferrule. Thus, the craft can easily insert optical fibers into the desired center bores of the ferrule (i.e., positions 6 and 7) of the connector. FIG. 14 shows a cross-sectional view of fiber tray 300 with non-transmitting outboard fibers or spacers 304 therein with channels 302 therebetween. Of course, the non-transmitting fibers can be arranged in a far-left or far-right arrangement leaving the channels 302 on respective sides of the fiber tray as desired. Fiber tray 300 can be formed from a piece of optical fiber ribbon having a top portion of the matrix stripped off and then removing the desired fiber from the same, thereby forming channels 302 and then cutting to the desired length.

Methods for making the cable assemblies are also disclosed. For instance, methods for making a cable assembly including the steps of providing a fiber optic cable having a first end and at least one optical fiber disposed within a longitudinal passageway of the fiber optic cable, placing a cushioning member about the first end of the fiber optic cable, and installing a connector on the first end of the fiber optic cable so that a crimp band of the connector is disposed over the cushioning member and the crimp band secures the fiber optic connector to the first end of the cable. Other optional steps for making cable assemblies include the step of securing a first portion of the crimp band to cushioning member and securing a second portion of the crimp band to the connector and/or placing the cushioning member over a jacket of the fiber optic cable.

As discussed, the method may include providing the fiber optic cable that is a sub-unit of a larger cable such as shown by FIG. 2, but other suitable cables having sub-units are possible according the concepts disclosed herein. Fiber optic cables having sub-units are typical furcated (i.e., separated into units), consequently, the methods disclosed may further include the step of furcating the fiber optic cable. Additionally, the manufacture of the cable assembly may include the step of aligning a plurality of optical fibers within the connector using a fiber tray. The method may also include the step of installing a single-fiber connector or a multi-fiber connector.

Although the disclosure has been illustrated and described herein with reference to preferred embodiments and specific examples thereof, it will be readily apparent to those of ordinary skill in the art that other embodiments and examples can perform similar functions and/or achieve like results. All such equivalent embodiments and examples are within the spirit and scope of the disclosure and are intended to be covered by the appended claims. It will also be apparent to those skilled in the art that various modifications and variations can be made to the present invention without departing from the spirit and scope of the same. Thus, it is intended that the present invention cover the modifications and variations of this invention provided they come within the scope of the appended claims and their equivalents.

We claim:

1. A cable assembly, comprising:
a fiber optic cable having a first end and at least one optical fiber disposed within a longitudinal passageway of the fiber optic cable;
a cushioning member disposed about the fiber optic cable; and
a connector attached to the first end of the fiber optic cable, wherein the connector includes a crimp band disposed over the cushioning member, and the crimp band secures the connector to the first end of the cable.

2. The cable assembly of claim 1, the fiber optic cable including a cable jacket wherein the crimp band is disposed about the cable jacket.

3. The cable assembly of claim 1, the fiber optic cable being a sub-unit of a larger cable.

4. The cable assembly of claim 1, the fiber optic cable being a tight-buffered optical fiber, a single fiber cable, or a jumper cable.

5. The cable assembly of claim 1, further including a furcation body having a plurality of sub-units extending therefrom, wherein the connector is attached to one of the plurality of sub-units.

6. The cable assembly of claim 1, the cushioning member being a heat shrink tubing.

7. The cable assembly of claim 1, the crimp band having a stepped profile with a first portion of the crimp band secured to the fiber optic cable and a second portion of the crimp band secured to a portion of the connector.

8. The cable assembly of claim 1, the fiber optic cable including a plurality of optical fibers loosely disposed within the passageway and being aligned within the connector using a fiber tray.

9. The cable assembly of claim 1, wherein the fiber optic cable includes a plurality of optical fibers and strength members disposed within the passageway.

10. The cable assembly of claim 1, the connector being a multi-fiber connector.

11. A cable assembly, comprising:
a fiber optic cable having a plurality of optical fibers disposed within a longitudinal passageway of a jacket of the fiber optic cable and fiber optic cable having a first end;
a cushioning member disposed about the jacket of the fiber optic cable; and
a connector attached to the first end of the fiber optic cable, wherein the connector includes a crimp band disposed over the cushioning member, and the crimp band has a stepped profile with a first portion of the crimp band secured to the fiber optic cable and a second portion of the crimp band secured to a portion of the connector.

12. The cable assembly of claim 11, the fiber optic cable being a sub-unit of a larger cable.

13. The cable assembly of claim 11, further including a furcation body having a plurality of sub-units extending therefrom, wherein the connector is attached to one of the plurality of sub-units.

14. The cable assembly of claim 11, the cushioning member being a heat shrink tubing.

15. The cable assembly of claim 11, the plurality of optical fibers being aligned within the connector using a fiber tray.

16. A method of making a cable assembly, comprising the steps of:
providing a fiber optic cable having a first end and at least one optical fiber disposed within a longitudinal passageway of the fiber optic cable;
placing a cushioning member about the first end of the fiber optic cable; and
installing a connector on the first end of the fiber optic cable so that a crimp band of the connector is disposed over the cushioning member and the crimp band secures the fiber optic connector to the first end of the cable.

17. The method of claim 16, further including the step of securing a first portion of the crimp band to cushioning member and securing a second portion of the crimp band to the connector.

18. The method of claim 16, wherein the step of placing the cushioning member includes placing the cushioning member over a jacket of the fiber optic cable.

19. The method of claim 16, the fiber optic cable being a sub-unit of a larger cable.

20. The method of claim 16, further including the step of aligning a plurality of optical fibers within the connector using a fiber tray.

21. The method of claim 16, further including the step of furcating the fiber optic cable.

22. The method of claim 16, the step of installing a fiber optic connector comprising installing a multi-fiber connector.
